(19) United States
(12) Patent Application Publication
(10) Pub. No.: US 2009/0276663 A1
(43) Pub. Date: Nov. 5, 2009

(54) Method and arrangement for optimizing test case execution

(76) Inventor: Rauli Ensio Kaksonen, Oulu (FI)

Correspondence Address: Ober, Kaler, Grimes & Shriver, 120 East Baltimore Street, Baltimore, MD, 21202-1643, US

(21) Appl. No.: 12/151,145

(22) Filed: May 2, 2008

(30) Foreign Application Priority Data
May 2, 2008 (FI) FI 20070344

(51) Int. Cl. G06F 11/36

(52) U.S. Cl. 714/25; 714/E11.207

(57) ABSTRACT

The present invention is a method for optimizing execution of plurality of test cases in a system under test. The method is characterized in that a first set of test cases comprising at least one test case to represent at least one second set of test cases is selected. Then an optimal value for a test execution parameter using data obtained from execution of the first set of test cases is determined. Finally, based on the result of the execution of the first set of test cases, an optimized value of at least one parameter related to execution of the at least one second test case is determined.

### CROSS-REFERENCE TO RELATED APPLICATIONS

The present application derives priority from Finland patent application No. FI 20070344, filed 2 May 2007.

### BACKGROUND OF THE INVENTION

1. Field of the Invention

The present invention relates to a method and arrangement for optimizing execution of test cases in a computer system.

2. Description of the Background

Testing systems of prior art typically provide a set of test cases that is executed in the same way regardless of the properties of the System Under Test (SUT). For example, a protocol specification may define large number of different messages and message attributes, but a product only implements a subset of the all possible features. Another problem of prior art solutions is the determination of test case parameter values, such as timeout values, for testing.

The problem is present in all testing, but it is highlighted in any test runs where the number of test cases is high. Non-optimal test case selection and test parameterization has there a bigger cost. This is true in robustness testing. In robustness testing, usually a large set of test cases are executed against the SUT. Each test case has some unexpected or even invalid component. The idea is to make the SUT fail and so discover quality, dependability or security problems.

As stated, for best effectiveness the used test cases and test parameters should be selected carefully. These values could be manually tuned before testing, but this requires time, in-depth understanding of the SUT, and in-depth understanding of the used testing paradigm (e.g. robustness testing). An average tester does not have all these expertise so test runs are performed in suboptimal manner, which wastes time and resources and leaves problems undetected.

For example, U.S. Pat. No. 7,134,113 discloses a method and system for generating an optimized suite of test cases. The method involves deriving set of use case constraints and generating optimized suite of test cases based upon use case constraints

U.S. Pat. No. 6,557,115 discloses a testing control method for manufactured products. The method involves determining optimum test sequence from the classified test failure data. The method identifies most frequently occurring faults in test cases and arranges the test cases into an order where those test cases are executed first.

U.S. patent application US20030046613 teaches a method for integrating test coverage measurements with model based test generation. The method involves continually running test suite against program under test and generating test cases until optimal test suite is developed.

U.S. Pat. No. 6,577,981 discloses a test executive system and method. The method involves configuring process model having common functionality for different test sequences, in response to user input and generating test sequence file.

U.S. Pat. No. 5,805,795 discloses a sample selection method for software products testing. The method involves determining fitness value for each subset corresponding to execution time of test cases and code blocks accessed by test cases. The program to be tested may have a number of code blocks that may be exercised during execution of the program. The method includes identifying each of the code blocks that may be exercised, and determining a time for executing each of the test cases in the set.

U.S. patent publications U.S. Pat. No. 6,795,790, U.S. Pat. No. 6,522,995, U.S. Pat. No. 7,000,224, US2006230320, US2003212704, US2005120276, US2005154559, US2003046029 and US2007168734 disclose various methods and arrangements related to optimizing execution of software processes in a computer.

The foregoing and other prior art fails to teach a probing method for automatic optimization of execution of a suite of test cases in a “black box” test, i.e. testing a system where information about the internal implementation of the functionality to be tested is not available when optimizing the execution of a test suite. It would be beneficial if a testing system could determine test execution parameters of such system automatically without human intervention or together with user.

### SUMMARY OF THE INVENTION

It is, therefore, an object of the present invention to provide a method and system for optimizing execution of a plurality of test cases in a system under test.

According to the present invention, the above described and other objects are accomplished with a method and arrangement to optimizing execution of a test suite comprising plurality of test cases based on information obtained from executing a small number of test cases. In the invention, a testing session where a set of test cases is executed, is preceded by a probing session during which optimal values for one or multiple test execution parameters are determined by executing at least one probing test case. Probing sessions may also be interleaved with the testing sessions. During probing a set of probe runs may be executed manually or automatically, possibly multiple times using different values of test execution parameter(s). The probe runs may be executed serially or in parallel. Based on the result of the probe run(s), a set of parameters comprising at least one parameter for the actual testing session that executes a plurality of test cases may be set.

The goal of the optimization may be e.g. coverage of tests or efficiency of test case execution.

In some embodiments, a tester computer may probe capabilities of a system under test, e.g. whether a system under test supports a feature, by using at least one illegal or invalid test data value in a test case of the probing session. The parameter(s) optimized by the probing test case may thus e.g. indicate whether further test cases for testing the feature itself or some related features should be executed. The parameter(s) may also indicate which test cases or types of test cases should be executed.

Some parameters, such as the timeout value or the number of test cases executed in parallel, may be used to optimize the test execution speed. Some parameters, such as supported modes, elements and messages, may be used to limit the number of test cases or to prioritize test cases. For example, it may not make sense to have tests for some feature which is not supported by the SUT at all. A test execution parameter may hence indicate whether a set of test cases should be executed or not. Results of the probe session may be used to shorten testing times or increase the number of test cases directed to the high priority features. As result of this, the test run efficiency may be increased.

Users may be required to perform some manual actions during the probing. For example, it may be required to enter passwords to the SUT for successful test execution. The probing may also consist of user to entering some parameters beside the probed parameters. Also, it may be beneficial if the user may override and tune the probed parameters or the optimized parameter values are made adjustable by some other means. For that purpose, the probing session may provide for example statistics data about the measured effect of different parameter values on performance.

The probed parameters may be saved to avoid the probing before a new test run. Probing may also be repeated before each test run to provide information about any change in the characteristics of the SUT. This information may be added to test results as additional benefit of the invention.

Probing may also include analyzing any logs or traces produced by the SUT. This may be done automatically, manually by the user or as a combination of the two.

Probing may also be embedded to be a part of the test run rather than having a separate probing session before the test run. Sometimes the probing session may also be performed without actual testing to only collect and store the gathered information.

The invention concerns a computer executable method for optimizing execution of plurality of test cases in a system under test. The method is characterized in that a first set of test cases comprising at least one test case to represent at least one second set of test cases is selected. Then an optimal value for at least one test execution parameter is determined using data obtained from execution of the first set of test cases. Finally, based on the result of the execution of the first set of test cases an optimized value of at least one parameter related to execution of the at least one second set of test cases is set.

The invention includes the computer executable program code capable of executing the method of the present invention, as well as storage media containing said code and an arrangement capable of executing the method of the present invention. The arrangement may thus be capable of optimizing the execution of a plurality of test cases in a computer system comprising at least one tester computer, at least one system under test and network communication means between the tester computer and the system under test. The arrangement may be characterized e.g. in that a tester computer comprises means for selecting a first set of test cases comprising at least one test case to represent at least one second set of test cases, means for determining an optimized value for a test execution parameter using data obtained from execution of the first set of test cases and means for setting the optimized value of at least one test execution parameter related to execution of the at least one second set of test cases in a system under test.

Some embodiments of the invention are described herein, and further applications and adaptations of the invention will be apparent to those of ordinary skill in the art.

### BRIEF DESCRIPTION OF THE DRAWINGS

Other objects, features, and advantages of the present invention will become apparent from the following detailed description of the preferred embodiments and certain modifications thereof when taken together with the accompanying drawings in which like numbers represent like items and in which:

FIG. 1 shows an exemplary arrangement comprising a testing computer and a system under test according to an embodiment of the invention;

FIG. 2 shows a flow chart about optimization of test case execution according to an embodiment of the invention; and

FIG. 3 shows a flow chart about determining a test execution parameter value according to an embodiment of the invention.

### DETAILED DESCRIPTION OF THE PREFERRED EMBODIMENTS

The present invention is a method for optimizing execution of a plurality of test cases in a system under test, as well as the computer executable program code capable of executing the method of the present invention, storage media containing said code, and an arrangement or and system capable of executing the method of the present invention.

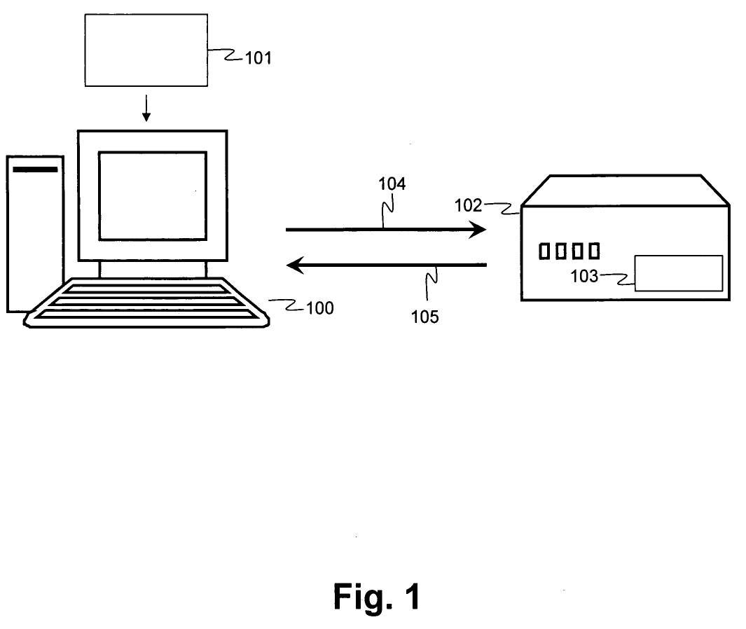

FIG. 1 illustrates an exemplary computer arrangement for executing the method of an embodiment of the present invention. The arrangement comprises a tester computer 100 that has access to some test case definition data 101. The tester computer is in network communication 104, 105 with a system under test (SUT) 102. The SUT comprises some functionality 103 that is being tested using a set of test cases in a test session. In one embodiment, a test case execution comprises assembling a message in the tester computer 100 and sending the message 104 to the system under test 102. The SUT processes the message and returns a response message 105 to the tester computer. The tester computer receives the response message and checks the content of the response message. Additionally, the tester computer may record additional information such as execution time of the test case or timeout condition occurred during execution.

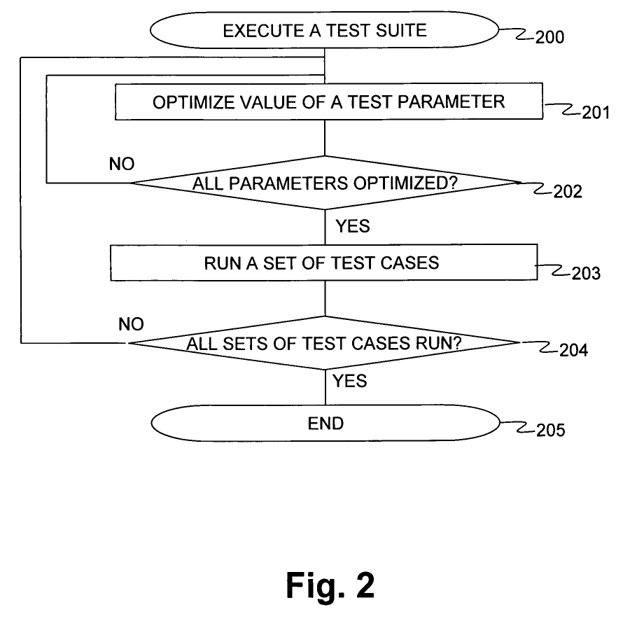

FIG. 2 shows a high-level flow chart of the method for optimizing execution of a test suite 200 comprising a plurality of test cases according to an embodiment of the present invention. Before executing a set of test cases specified in the test suite, a value of a test case execution parameter is optimized 201. There may be more than one test case execution parameter whose value needs to be optimized. Once all desired parameter values have been optimized 202, the test cases of the specified set are executed using the optimized test case execution parameter values 203. If there are further sets of test cases 204 that need to be executed with at least partially different test case execution parameters, the parameter value optimization step 201 and subsequent test case execution step 203 are re-run.

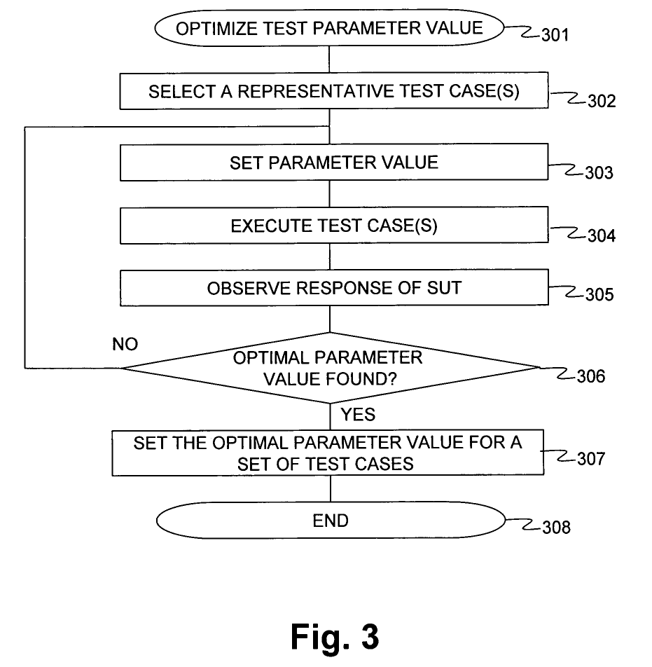

FIG. 3 shows a more detailed flow chart for determining optimal value 301 for a test case execution parameter. According to an embodiment of the present invention, at least one test case needs to be selected 302 from a set of test cases to represent the set. Then an initial parameter value is determined 303.

The parameter value may for example be a timeout value. Timeout gives the length of time how long the tester waits for a response from the SUT before proceeding without getting the reply. Often the SUT is not responding when the tester expects it to, and on those situations the tester should move as fast as possible to next test case. Finding the right timeout value is essential for test throughput. A too-short timeout means that the SUT is not able to respond to the tester even if it is working properly and test sequences are terminated prematurely. This leads to inconclusive test cases, which produce no results. On the other hand, a too-long timeout means that the tested spends long times waiting for a response from the SUT. The right timeout value may be probed by running some test case(s). In this exemplary embodiment, the cases may be selected from test cases that are generally known to pass without problems. Then a test case is executed 304 with initial timeout value and the response is observed 305 by the tester computer. The test case may be re-executed 306 using different timeout values and the optimal parameter value (e.g. smallest timeout where SUT responds to the tester in reliable manner) is selected 307. The tester may choose to use a conservative value by adding some constant to the probed value.

To continue with the example of selecting an optimal timeout value, a simple algorithm is to start with very small timeout, e.g. 1 millisecond, and double the timeout as long as it appears to be too small. This execution of test case(s) is continued serially as long as it takes to find a value which is long enough. The optimum value is between the found value and the largest failed value, which should be e.g. half of the found value. The tester may then try value exactly between the two values. If this value is also acceptable, then the tester computer should try smaller value. If the value is too short then the tester should try bigger value. This process may be then repeated as long as the optimal value is found.

In another embodiment of the invention, a tester may run multiple test cases in parallel to speed up test execution. However, running too many test cases in parallel starts to slow down the test execution speed due increased overhead in the tester machine or machines or in SUT.

A tester may probe the right number of parallel test cases by running varying number of test cases in parallel. Optimum number of parallel test cases is the one which gives most test cases per time unit (test case throughput).

A simple exemplary algorithm to find the right number of parallel test cases is to start with one test case in parallel, run a while, and note the test case throughput. The measurement is repeated for 2, 3, 4, etc. test cases in parallel. The search may end when the test cases throughput starts to degrade. Alternatively the measurements may be performed by doubling the number of parallel test cases for each probe run to 2, 4, 8, 16, etc. test cases in parallel. After the test cases throughput starts to degrade, the optimal number of parallel test cases is searched between last two values.

It should be noted that the algorithms described herein are only exemplary and used only for illustrating the inventive idea of the present invention and any other suitable algorithms may be used to resolve the optimal number of parallel test cases.

In some embodiments, a preferably small set of test cases (comprising at minimum one test case) may be used for determining whether a set of features is supported by the SUT. For example, HTTP (HyperText Transfer Protocol) and SIP (Session Initiation Protocol) protocols messages are made up of a set of headers. The number of available headers is large and different SUTs can understand different headers. Usually a SUT simply ignores headers it does not support and having test cases for them is unlikely to produce any useful data. An optimal test run contains header-specific test cases only for those headers which are supported by the SUT in question. Without this information, the header-specific tests must be run always for all headers.

To determine the set of headers or in more general, a set of supported features requiring testing, the tester computer (100 in FIG. 1) may probe if the SUT (102 in FIG. 1) supports a feature by using some illegal or invalid value for the feature. A SUT which supports the feature may respond to this with some error reply or warning reply. Presence of such error or warning may indicate that the SUT at least parses the feature, so it should be tested. Further, the probing may include multiple valid and illegal and invalid feature values. Variation in the reply from the SUT may indicate that it at least parses the feature.

This is best illustrated by an example. A SIP INVITE message, which initiates a phone call, starts with request line and headers, one header per line. The message might look like e.g. the following: [001]

INVITE sip:user@192.168.2.61 SIP/2.0

Content-Length: 333

Via: SIP/2.0/UDP 192.168.2.61;rport;branch=z9hG4bK2131231231

Contact: <sip:ababa@192.168.2.61:5060>

Call-ID: 12313213211@192.168.2.61

Content-Type: application/sdp

CSeq: 1 INVITE

From: “user”<sip:abba@192.168.2.61>;tag=3402139377218

To: <sip:default@192.168.3.201>

User-Agent: SIP Tester

. . .

Note that for practicality, the rest of the INVITE message after the headers are omitted.

For a proper INVITE message, a SIP entity responds with SIP TRYING message and SIP OK message etc. A tester computer may probe which headers are most interesting for robustness testing by trying out different invalid header values to figure out which headers are actually parsed by the SUT. For example, by sending the following kind of message, the tester might probe if the SUT supports Content-Length-header.

INVITE sip:user@192.168.2.61 SIP/2.0

Via: SIP/2.0/UDP 192.168.2.61;rport;branch=z9hG4bK2131231231

Content-Length: XXXXXXXXXX

Contact: <sip:ababa@192.168.2.61:5060>

Call-ID: 12313213211@192.168.2.61

Content-Type: application/sdp

CSeq: 1 INVITE

From: “user”<sip:abba@192.168.2.61>;tag=3402139377218

To: <sip:default@192.168.3.201>

User-Agent: SIP Tester

. . .

If the SUT responds differently compared to the valid INVITE message, it may indicate that the SUT does indeed process the Content-Length-header. Similarly invalid values may be applied to other headers: Via, Contact, Call-ID, Content-Type, CSeq, From, To and User-Agent. The results from the probing might be like in the following table.

| Malformed header | Response | Parsed by SUT? |
|---|---|---|
| Content-Length | BAD REQUEST | Yes |
| Via | BAD REQUEST | Yes |
| Contact | TRYING, OK | No |
| Call-ID | BAD REQUEST | Yes |
| Content-Type | BAD REQUEST | Yes |
| CSeq | BAD REQUEST | Yes |
| From | (no reply) | Yes |
| To | (no reply) | Yes |
| User-Agent | TRYING, OK | No |

The tester may now drop the tests for headers Contact and User-Agent, and so achieve more optimal test suite.

Similarly to SIP header processing above, a tester computer may probe for any kind of supported features by sending messages with different feature or features in them and resolving from the SUT responses whether the SUT supports the probed feature. The method may be applied to all protocols, not just to SIP as done in the example.

Sometimes the SUT may specifically respond if it supports a specific feature. The SUT may also sometimes give a list of features it supports. In these cases the tester may directly use this information.

For a feature, where there is a specific response or behavior the SUT must provide when the feature is present, the tester computer checks if this response or behavior is produced by the SUT. Alternatively the tester can ask the user if the SUT produced the behavior.

In one embodiment of the present invention, probing of supported messages is provided. Probing of supported messages may be performed e.g. identically to probing of supported features. The probed feature is a message, but the process may be identical.

In some embodiments, the probing of supported features may be performed in the following way. The SUT is sent a message or messages which contain the probed feature in a valid form. If the SUT does not produce an error message, it may indicate that it supports the feature. The method of this embodiment may be useful e.g. with optional messages, where some optional message may or may not be supported by the SUT. Sending the optional message and observing response from the SUT may indicate if the SUT indeed supports and parses the message and further if there should be tests for it. This is in a way reverse logic compared to the earlier presented embodiment illustrated by the SIP example.

For testing of decoder logic, such as URL decoding (also called percent encoding), it is often important to know which parts of a protocol can be encoded and which cannot. Tester computer may check if SUT supports encoding of a message field by sending the message twice, in one message the field is not encoded and in another message the field is encoded. If the SUT behaves the same way, if has successfully decoded the encoded field value and it may support the encoding for the field. Additional confidence may be gained by sending a third message where the field is given an invalid value. The SUT should reject this message or give an error indication. This may provide additional confidence that the SUT does indeed parse the field and not just ignore it.

This is best illustrated by an example. In the previously shown SIP message, we can probe the support for URL encoding in Content-Length header. URL encoded for of string “333” is “%33%33%33” (ASCII code for digit ‘3’ is 33 in hexadecimal). The following SIP INVITE message would probe the URL encoding support of the SUT:

INVITE sip:user@192.168.2.61 SIP/2.0

Content-Length: %33%33%33

Via: SIP/2.0/UDP 192.168.2.61;rport;branch=z9hG4bK2131231231

Contact: <sip:ababa@192.168.2.61:5060>

Call-ID: 12313213211@192.168.2.61

Content-Type: application/sdp

CSeq: 1 INVITE

From: “user”<sip:abba@192.168.2.61>;tag=3402139377218

To: <sip:default@192.168.3.201>

User-Agent: SIP Tester

. . .

If the SUT responds normally to the above message, this information may be combined to the previous probing conclusion, which was that the Content-Length-field is parsed by the SUT and conclude that URL encoding is supported in the Content-Length-field. Now the tester computer may use this information and e.g. design more tests for testing the URL encoding support in the Content-Length field. The same process may be repeated to all headers that were earlier found to be parsed by SUT.

Some protocols to be tested may have several different operation modes. In each operation mode the protocol may perform the same basic function, but in different way. For example, in TLS (Transport Layer Security) and SSL (Secure Socket Layer) protocols, the cipher suite determines the used cryptographic algorithms. TLS and SSL provide always a secure communication tunnel, but the details vary depending on the cipher suite. Another example is the different exchange sequences used in ISAKMP (Internet Security Association and Key Management Protocol). All sequences are used to establish the key required for secure communication. In some embodiments, the SUT may specifically respond if it supports a specific operation mode. The SUT may also sometimes give a list of the modes it supports. In these embodiments the tester may directly store this information. Further, the tester computer may perform the same sequence in different operation modes. If the behavior from the SUT is different for two operation modes, then it may be desirable to have tests for the both modes. This may be generalized to several different modes, test may be executed for different modes so that all observed different behaviors from the SUT have test cases for them.

In another embodiment of the present invention, probing supported modes of operation of the SUT is provided. For example, TLS and SSL communication security solutions support different cipher suites. A cipher suite determines the used cryptographic algorithms and their parameters. Also, the messages used and allowed in a TLS/SSL sequence are dependent on the cipher suite. A single SUT is unlikely to support all possible cipher suites. Ideally a test run should include into message-specific test cases only those messages, which are used in the cipher suites supported by the SUT. Also, some test cases may be desired to be repeated for all supported cipher suites. An operation mode may be probed for example by running a simple sequence once for all different operation modes. Those modes, for which the sequence goes through without problems, are marked as supported.

In the TLS/SSL case this may mean running a valid TLS/SSL handshake once for all cipher suites. For all 28 different cipher suites specified in RFC2246, total of 28 different handshakes are ran, each with different cipher suite. For each handshake, the behavior of the SUT is observed. Cipher suites which produced the handshake to pass may be supported by the SUT. Cipher suites whose handshakes did not proceed beyond the message where cipher suite is selected may not be supported. A handshake which proceeded beyond the cipher suite selection message, but did not finish, may indicate some kind of interoperability problem between the SUT and tester computer. For robustness testing, those cipher suites may be included as well.

The following provides an exemplary list of test execution parameters which may be automatically resolved before testing using embodiments of the method and arrangement described herein.
Timeout value or multiple timeout values
Number of parallel sessions in testing
Supported headers, e.g. in SIP or HTTP
The optional protocol messages supported by SUT, e.g. different authentication methods in SSH (Secure Shell) and in EAP (Extensible Authentication Method) or support for Register message in SIP
The optional protocol elements supported by SUT, such as option headers in IPv4 and IPv6 and extension headers in GTP (GPRS Tunneling Protocol)
The operation modes supported by the SUT, e.g. cipher suite in TLS and SSL, exchange sequences in ISAKMP
Supported attributes, e.g. Radius attributes in RFC2865
Supported encodings, such as URL encoding
Supported encryption and other cryptographic algorithms
Supported carrier protocols, e.g. UDP, TCP, SCTP, etc.
Supported application protocols carried by the tested protocol, e.g. TLS/SSL may carry HTTP, SIP, and other payload protocols, and UDP, TCP and SCTP may carry large set of payload protocols
Supported profiles, such as Bluetooth profiles
Supported data types, e.g. ASN. 1 data types
Supported character sets, e.g. UTF-8 (Unicode Transformation Format), UTF-16, etc.
Supported specification or protocol versions, e.g. support for HTTP/1.0 or support for HTTP/1.1

The support or no-support decision does not need to be solely made on basis of external SUT behavior. For example, execution flow analysis of the SUT may be used. In this technique the execution flow of the SUT is recoded for different runs and then compared. For example, when probing the support of a SUT for a SIP header, the execution flow for a valid SIP header and invalid SIP header is recorded. If the execution flow is identical, it may indicate that the SUT does not support the header. If the execution flow differs, then there is a difference in behavior and it may indicate that the SUT supports the header. This information may be combined with information from the external SUT behavior.

Having now fully set forth the preferred embodiment and certain modifications of the concept underlying the present invention, various other embodiments herein shown and described will obviously occur to those skilled in the art upon becoming familiar with said underlying concept. It is to be understood, therefore, that the invention may be practiced otherwise than as specifically set forth in the appended claims.

I claim:

1. A computer executable method for optimizing execution of test cases in a computer system comprising at least one system under test, comprising the steps of:
a. selecting a first set of test cases comprising at least one test case to represent at least one second set of test cases;
b. determining an optimized value for a test execution parameter using data obtained from execution of the first set of test cases; and
c. setting the optimized value of at least one test execution parameter related to execution of the at least one second set of test cases in a system under test.

2. A method according to claim 1, wherein said test case of said first set of test cases uses at least one invalid data value to probe capabilities of said system under test.

3. A method according to claim 1, wherein said optimized parameter value expresses whether a feature is supported by said system under test.

4. A method according to claim 1, wherein said optimized parameter value expresses whether at least one test case of said second set of test cases should be executed by said system under test.

5. A method according to claim 1, wherein said step of determining an optimal value comprises the following substeps:
a. altering the value of said test execution parameter,
b. executing at least one test case of said first set of test cases using the new parameter value,
c. observing the response from said system under test, and
d. repeating steps a-c until optimal value has been found.

6. A method according to claim 5, wherein said substep of observing the response comprises measuring response time of execution of at least one test case of said first set of test cases.

7. A method according to claim 1, wherein a plurality of test cases of said first set of test cases are executed serially.

8. A method according to claim 1, wherein a plurality of test cases of said first set of test cases are executed in parallel.

9. A method according to claim 1, wherein said optimized value is stored into memory means of a tester computer.

10. A method according to claim 1, wherein said optimized value is adjusted before execution of said second set of test case.

11. An arrangement for optimizing execution of plurality of test cases in a computer system comprising at least one tester computer communicatively connectable to at least one system under test using network communication means between the tester computer and the system under test, the tester computer comprising:
a. means for selecting a first set of test cases comprising at least one test case to represent at least one second set of test cases;
b. means for determining an optimized value for a test execution parameter using data obtained from execution of the first set of test cases; and
c. means for setting the optimized value of at least one test execution parameter related to execution of the at least one second set of test cases.

12. An arrangement according to claim 11, wherein said tester computer is arranged to use said test case of said first set of test cases producing an invalid value to probe capabilities of said system under test.

13. An arrangement according to claim 12, wherein said optimized value expresses whether a feature is supported by said system under test.

14. An arrangement according to claim 12, wherein said optimized value expresses whether at least one test case of said second set of test cases should be executed by said system under test.

15. An arrangement according to claim 11, wherein said tester computer comprises following means for determining said optimal value:
a. altering the value of said test execution parameter,
b. executing at least one test case of said first set of test cases using the new parameter value,
c. observing the response from said system under test, and
d. repeating steps a-c until optimal value has been found.

16. An arrangement according to claim 15, characterized in that said means for observing the response comprises means for measuring response time of execution of at least one test case of said first set of test cases.

17. An arrangement according to claim 11, characterized in that said tester computer comprises means for executing a plurality of test cases of said first set of test cases serially.

18. An arrangement according to claim 11, characterized in that said tester computer comprises means for executing a plurality of test cases of said first set of test cases in parallel.

19. An arrangement according to claim 11, characterized in that said tester computer comprises means for storing said optimized value into persistent memory means of said tester computer.

20. Software for optimizing execution of test cases in a computer system comprising a tester computer communicatively connectable to at least one system under test, said software comprising computer executable program code for:
a. selecting a first set of test cases comprising at least one test case to represent at least one second set of test cases;
b. determining an optimized value for a test execution parameter using data obtained from execution of the first set of test cases; and
c. setting the optimized value of at least one test execution parameter related to execution of the at least one second set of test cases in a system under test.

21. A storage media containing software for optimizing execution of test cases in a computer system according to claim 20.

22. A system for optimizing execution of plurality of test cases in a computer system, comprising:
at least one tester computer;
at least one system under test;
network communications between the tester computer and the system under test; and
software resident on said tester computer for optimizing execution of test cases in said computer system, said software including computer executable program code for performing the steps of,
selecting a first set of test cases comprising at least one test case to represent at least one second set of test cases,
determining an optimized value for a test execution parameter using data obtained from execution of the first set of test cases, and
setting the optimized value of at least one test execution parameter related to execution of the at least one second set of test cases in a system under test.
